(19) United States
(12) Patent Application Publication
(10) Pub. No.: US 2006/0195657 A1
(43) Pub. Date: Aug. 31, 2006

(54) Expandable RAID method and device

(75) Inventors: Paul Tien, Fremont, CA (US); Wei Gao, Carmel, CA (US); Zhiqiang Zeng, Fremont, CA (US); Alex Win, Dublin, CA (US); Yasuaki Hagiwara, Newark, CA (US)

Correspondence Address: HAYNES BEFFEL & WOLFELD LLP, P O BOX 366, HALF MOON BAY, CA, 94019, US

(73) Assignee: Infrant Technologies, Inc., Fremont, CA (US)

(21) Appl. No.: 11/068,296

(22) Filed: Feb. 28, 2005

(51) Int. Cl. G06F 12/16

(52) U.S. Cl. 711/114

(57) ABSTRACT

The present invention relates to RAID arrays with one or more dedicated parity disks. In particular, it relates to expandable RAID arrays. An expansion disk can be added to a RAID array without the need of redistributing striped data among disks.

### BACKGROUND OF THE INVENTION

The present invention relates to RAID arrays with one or more dedicated parity disks. In particular, it relates to expandable RAID arrays.

The acronym RAID stands for redundant array of inexpensive disks. David Patterson and his colleagues from University of California at Berkeley, Department of Electrical Engineering and Computer Sciences were among the first to describe RAID arrays with protection levels designated as RAID 1, RAID 2, RAID 3, RAID 4 and RAID 5. D. A. Patterson, G. Gibson, and R. H. Katz. A case for redundant arrays of inexpensive disks (RAID). ACM SIGMOD International Conference on Management of Data, pages 109-116, 1-3 Jun. 1988. Among the RAID protection levels, RAID 3 and RAID 4 provided a dedicated parity disk. RAID 3 and RAID 4 differed in that RAID 3 striped data across disks in small chucks and RAID 4 used slightly larger chunks, so that a small block might be written completely to a single disk. The disadvantage of RAID 4, as described by Patterson, was that while RAID 4 achieves parallelism for reads, writes are still limited to one per group since every write to a group must read and write the parity disk. This disadvantage relates in part to Paterson's teaching that the new parity for a write to a single sector would be calculated as, new parity=(old data XOR new data) XOR old parity. This calculation avoided the need for multiple reads of non-parity disks to calculate new parity values. With limited or shared disk access channels available and relatively slow disk access, it has been essential to minimize data read-back requirements for parity calculation.

Practical implementations of RAID with a dedicated parity disk stripe of data across non-parity disks. Striping means dividing the data in small chunks and distributing each write across all of the non-parity disks (with an update to the parity disk, as well.) Network Appliance currently describes a product identified as NetApp F540 that implements RAID 4 with striping. Network Appliance—Optimizing Data Availability with the NetApp F540-[TR 3013] accessed at http://www.netapp.com/tech_library/3013.html?fmt=print on Jan. 29, 2005. Similarly, NetCell currently describes its SyncRAID hardware solution as having RAID 0 performance and RAID 5 reliability. Product descriptions make it quite likely that SyncRAID stripes data across non-parity disks following RAID 3 protocols, which NetCell has recoined “RAID XL”. See, SyncRAID Software Solutions, accessed at http://www.netcell.com/pdf/SyncRAID%20Solutions.pdf on Jan. 29, 2005; see, also, U.S. Pat. Nos. 6,018,778 and 6,772,108, assigned to NetCell Corporation.

While striping data achieves parallel access in some circumstances, thereby improving throughput, it is very difficult to expand a striped array by adding an additional disk. Adding a disk to a striped array involves rewriting both parity and non-parity disks in the array to redistribute data among old and new disks. Redistributing the data changes parity values stored on the parity disk, so the parity disk is rewritten as well.

An opportunity arises to introduce a variation on RAID that remains efficient, while accommodating added disks to expand of storage.

### SUMMARY OF THE INVENTION

The present invention relates to RAID arrays with one or more dedicated parity disks. In particular, it relates to expandable RAID arrays. Particular aspects of the present invention are described in the claims, specification and drawings.

### BRIEF DESCRIPTION OF THE DRAWINGS

FIG. 1 depicts a RAID array including a controller, non-parity disks and a parity disk.

FIG. 2 illustrates writing a single block of data to non-parity disk.

FIG. 3 illustrates writing blocks of data to non-parity disks.

FIG. 4 illustrates the problem of small writes.

FIG. 5 illustrates an alternative configuration of reads and writes without striping bits, bytes or blocks across non-parity disks and without successive reads and writes to any one disk.

FIGS. 6-7 illustrate adding a non-parity disk to an array.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

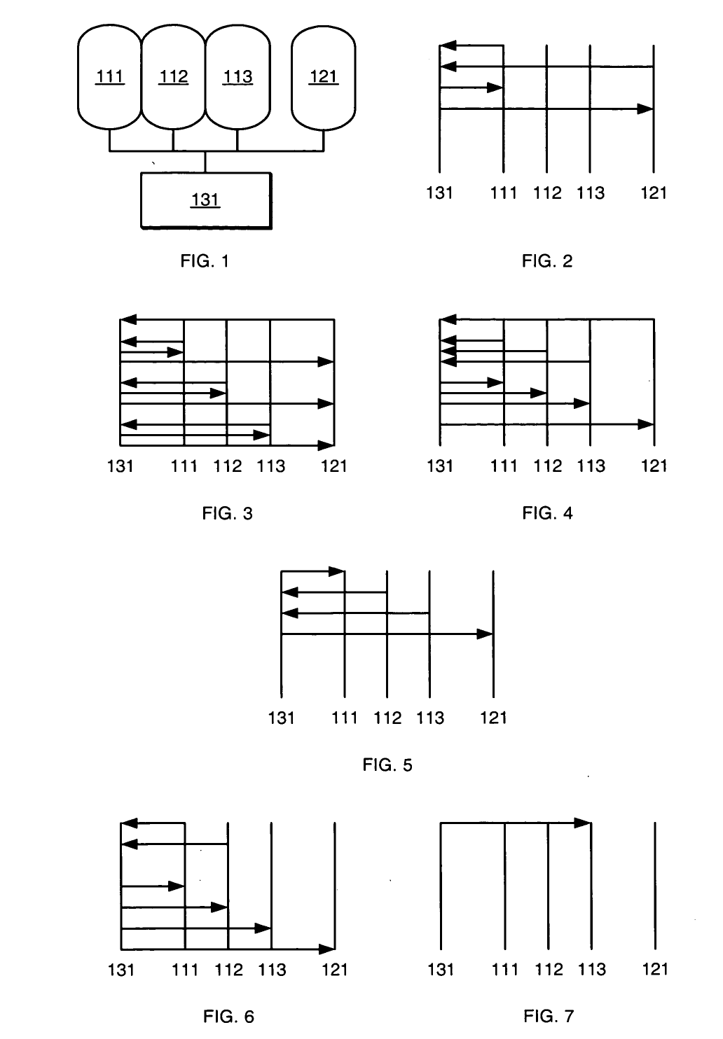

FIG. 1 depicts a RAID array including a controller 131, non-parity disks 111, 112, 113 and a parity disk 121. While three non-parity disks are illustrated, the description that follows applies as well to an array with two or more non-parity disks, including an array to which a second non-parity disk is being added. When a SCSI interface is use between the controller 131 and the disks, the same channel may be shared among the SCSI disks, which simplifies the controller but slows access. When ATA/IDE or EIDE interfaces are used, two disks may share a channel as master and slave drives or primary and secondary drives, or each disk can use a separate interface. With newer SATA drives, separate channels are typically used. With fibre channel and InfiniBand, physical media or bus is shared and channels are logically built and torn down.

Raid 3 and RAID 4 protocols, as described by Patterson, can be understood by reference to FIG. 1. Practicing RAID 3, small quantities of data, such as bits or bytes of data, are striped across the non-parity disks 111-113. Parity data is stored on the parity disk 121. Practicing RAID 4, blocks of data are successively written to the non-parity disks 111-113. Care must be taken to keep the non-parity data on disk 121 current, in case writing is interrupted before blocks have been written to all of the non-parity disks. Paterson teaches that this leads to updating the parity disk 121 after each block write to any of the non-parity disks, which hampers throughput.

Practicing RAID 4, FIG. 2 illustrates writing a single block of data to non-parity disk 111. Patterson teaches that RAID 4 can efficiently be practiced by recalculating the parity data to be written to parity disks 121 using old and new values of target disk 111 data plus data from the parity disk 121, without reading the additional non-parity disks 112, 113. The logical formula is given in the background section. As illustrated in FIG. 2 and taught by Paterson, writing a block to non-parity disk 111 requires reads from both the non-parity disk 111 and the parity disk 121 plus writes to update both disks. To accomplish a single block write, the system needs successively to read and write from the target non-parity disk and from the parity disk.

Practicing RAID 4, FIG. 3 illustrates writing blocks of data to non-parity disks 111, 112 and 113. This figure illustrates protection against interruption between block writes to successive non-parity disks. In the figure, the system reads the parity disk. To avoid cluttering the diagram, we designate this read as 131<-121, indicating data transferred to the controller 131 from the parity disk 121. Successively reusing what it knows about updated parity values on the parity disk, the system reads and writes blocks to non-parity disks, updating the parity disk is it updates individual non-parity disks. For instance, with initial parity values already cached from 131<-121, the system reads 131<-111 and then writes 131->111 and 131->121. For the next blocks, with updated parity values remembered from 131->121, the reads and writes are 131<-112, 131->112 and 131->121.

Practicing RAID 3, FIG. 4 illustrates the problem of small writes, which Patterson addressed using RAID 4. In general, disk input-output is performed on a block basis, not byte-by-byte. Many input-output transactions involve less a whole block of data, especially when a block a striped across N disks, effectively increasing the block size by the factor N. When data is striped across all of the non-parity disks in the array, a small write requires at least reading all of the blocks are being partially updated, 131<-111, 131<-112, 131<-113, updating the blocks, 131->111, 131->112, 131->113, and writing the parity disk, 131->121. In fact, the parity disk may need to be written for each non-parity disk update, as shown in FIG. 3. The disks in the array are involved in successive reads and writes.

In contrast to RAID 3 and RAID 4, FIG. 5 illustrates an alternative configuration of reads and writes without striping bits, bytes or blocks across non-parity disks and without successive reads and writes to any one disk. If there are three non-parity disks, data can be written until disk 111 is full and then spanned to disks 112 and 113 in turn. As will be shown later, this simplifies adding disks to the array.

As described in the background section above and illustrated by FIG. 2, Patterson taught reading the parity of the target disk and parity disk, then calculating new parity=(old data XOR new data) XOR old parity. This avoided reading multiple non-parity disks. Contrary to Patterson, this approach involves reading all of the non-parity disks in the array other than the target disk and calculating the new parity value using the multiple non-parity disks. Because the target value the target disk is known, new parity values can be calculated and the parity disk write-update can begin as soon as data begins arriving from the non-target, non-parity disks. It is not necessary to wait for completion of block reads before beginning block output to the parity disk.

While parallel disk access is commonly believed to make RAID reads and writes faster than access to a single disk, FIGS. 2-4 show that the approach in FIG. 5 can actually be faster for writes. FIG. 5 shows an embodiment that does not need both to read and write from any single disk when performing an update write. Using distinct or parallel disk access channels and parallel hardware, the write to the target disk 131->111 and reads from non-target, non-parity disks 131<-112, 131<-113, can proceed concurrently or in parallel. The write to the parity disk 131->121 can start as soon as the first bytes arrive from the non-parity disks 112, 113. The entire process of writing the target disk, retrieving data for calculation of parity values and writing parity values to the parity disk takes only slightly longer than writing to the target disk, because no disk requires both a read and a write. The need for separate physical channels when reading concurrently depends on the bandwidth of a physical channel relative to the data throughput of a single disk. A high bandwidth channel can accommodate several logical channels without causing delay in data acquisition. It may be useful when using RAID without striping to have sufficient channel bandwidth, logical or physical, that concurrently reading from all of the non-parity disks or all but one of the non-parity disks is not limited by channel availability, channel throughput or other disk access channel characteristics.

FIGS. 6-7 illustrate adding a non-parity disk to an array. Referring to FIG. 1, suppose that the array begins with two non-parity drives 111, 112, which have data, and a third non-parity drive 113 is added. FIG. 6 illustrates adding the third non-parity drive to a striped array. When RAID disks are striped, data is spread among the non-parity disks. If CAPS indicate data stored on drive 111 and lower case on 112, then a few words MiGhT Be StOrEd wItH AlTeRnAtE LeTtErS On dIsKs 111, 112. Or, alternate bits might be stored on different non-parity disks. The striping proceeds according to a pattern, typically a pattern for whole disks. When another drive is added, the pattern changes, so data is moved to where it would have been if the other drive had been installed when the data was first written. The system in FIG. 7, with two non-parity disk and an added third non-parity disks reads data 131<-111, 131<-112, reorganizes the data across the expanded array of disks, 131->111, 131->113, 131->113, calculates and writes the new parity values 131->121.

FIG. 7 depicts the ease of expansion when data is not striped and the added disk is specially prepared. This diagram supposes that disks are used without striping and that new disks become available free space. A new disk is added and prepared in a way that retains the validity of the parity values on parity disk 121. The parity values typically can be calculated by sequentially applying XOR operators to data on the non-parity disks in the array. Alternatively, XNOR operators can be used. For either XOR or XNOR operators, a new disk effectively initialized to all zeros will not change the parity values on the parity disk 121. This is logically the case irrespective of the number of non-parity disks or any values on the non-parity disks. Whether the result of applying the operators is a “1” or a “0”, combining the result with another “0” leaves it unchanged. The parity values on the parity disk do not need to be recalculated when a non-parity disk effectively initialized to all zeros is added to the array. The write 131->113 is to prepare the disk. When actual data is written, the procedure will be as depicted in FIG. 5.

Effectively preparing the added non-parity disk may involve physically writing zeros to the disk or logically marking sectors of the disk as having zero values. For instance, a data area in a reserved track of the disk could contain a bit string used to indicate, with a single bit, whether a particular section of the disk should be logically treated as if zeros had been physically written. This information, as flag bits or bytes or in another format, could be spread across areas of the disk or even applied as header information in sections or blocks of the disk. Alternatively, it could be stored in memory on a RAID controller, in a table established when the expansion disk is first detected. If stored on the RAID controller, non-volatile memory may be used.

Alternatively, adding an expansion disk when data is not striped may involve using the expansion disk with whatever data it holds. Adding an expansion disk without striping and arbitrary data values requires recalculating parity values stored on the parity disk, to take into account data values on the expansion disk. This can be done on demand or in the background. Updated parity values can be calculated either from the parity disk and the expansion disk, or from the non-parity disks including the expansion disk. Using the parity disk and the expansion disk requires reads from both disks, followed by a write to the parity disk. Using all of the non-parity disks requires reads from all of those disks and a write to the parity disk. In this way, no disk need be involved in both a read and write. To support either on demand or background updating of parity values, the system can logically mark sections of the expansion disk as being available. For instance, a data area in a reserved track of the disk could contain a bit string used to indicate, with a single bit, whether a particular section of the disk has been incorporated into the parity calculations for the parity disk. This information, as flag bits or bytes or in another format, could be spread across areas of the disk or even applied as header information in sections or blocks of the disk. Alternatively, it could be stored in memory on the RAID controller, in a table established when the expansion disk is first detected. If stored on the RAID controller, non-volatile memory may be used. Either on demand or in the background, parity values of the parity disk can be calculated and updated section by section. The larger the section, the less overhead required to keep track of whether the section has been processed and become available.

### Some Particular Embodiments

The present invention may be practiced as a method or device adapted to practice the method. The same method can be viewed from the perspective of operations carried out by a controller or a human operator who adds a disk to an array. The invention may be an article of manufacture such as media impressed with logic to control a RAID array.

One embodiment is a method of adding an expansion disk to a disk array with at least one dedicated parity disk. This method includes storing data on one or more first, non-parity disks of the disk array. Data is stored without striping across the first disks. That is, there is no striping pattern that depends on the number of disks across which data is distributed. The method further includes storing parity data for the first is on a parity disk in the disk array. An expansion disk is added having initial data values on the expansion disk that preserve the validity of the parity values recorded on the parity disk. The initial data values may be physically written on the expansion disk or implied. The expansion disk can be added without having to recalculate parity values on the parity disk and without needing to reorganize data among the first, non-parity disks.

One aspect of this method may be setting initial data values on the expansion disk effectively to zeroes. Zeros may be written as initial data values on the expansion disk or one or more flags may be set to indicate that values on the disk should be considered to be zero. Bits or bytes may suitably be used as flags and may be collected in one place on the expansion disk or distributed across the expansion disk. Alternatively, one or more ranges of locations on the disk may be indicated as considered to be zero. These ranges of locations may be updated as portions of the disk are physically initialized. Parity values recorded on the parity disk may be calculated using an XOR or an XNOR of data values across the first disks. If the different calculation of parity values is used, different initial values may be applied. Flags may be used to exclude from parity calculation sections of the expansion disk that have not yet been initialized, effectively setting them to value that preserves the validity of parity values recorded on the parity disk.

An alternative embodiment uses whatever initial values are on the expansion disk and updating sections of parity values on the parity disk using background resources and/or on demand. This embodiment includes adding an expansion disk to the array with sections of the expansion disk and keeping track of sections of the expansion disk as not included in calculation of parity values on the parity disk; and using background resources or on demand, updating sections of parity values on the parity disk by recalculating the sections of parity values to include corresponding sections of the expansion disk and keeping track of the recalculated sections as having been included in calculation of parity values on the parity disk. Other aspects and options applied to preceding methods optionally apply to this embodiment as well.

Another embodiment is a disk controller including resources, logic and input-output channels adapted to carry out the method embodiment described in the three preceding paragraphs. The aspects of options of the method embodiment are optional features of the disk controller embodiment.

A further embodiment is a method of writing to a disk array with two or more first disks, at least one dedicated parity disk and one or more available expansion disk access channels. This method includes writing data without striping to a particular disk among the first disks in the disk array. It further includes reading concurrently from remaining first disks in the disk array other than the particular disk. Optionally, reading and writing use distinct disk access channels for the disks. Optionally, the writing data to the particular disk and the reading concurrently from the remaining disks overlap, because distinct disk access channels are in use. The method further includes calculating parity values protecting the data destined for the particular disk using data from the remaining first disks and writing the calculated parity values to the parity disk. Optionally, the writing calculated parity values to the parity disk may overlap with reading concurrently from the remaining first disks, because distinct disk access channels are in use. Further, writing data to the particular disk, reading concurrently from the remaining first disks and writing parity values may overlap, as writing data to the particular disk does not depend on reading from the remaining first disks and writing parity values may begin as soon as data begins arriving from the remaining first disks, so that parity values can be calculated. A useful aspect of some variations on this embodiment is that no disk in the disk array need be accessed for both a read and a write to support the write to the particular disk.

This method may further include adding an expansion disk the disk array using one of the available expansion channels and continuing to use the first disks while making available the expansion disk to store data without recalculating pre-expansion parity values on the parity disk to accommodate the expansion disk.

This method alternatively may further include adding an expansion disk to the disk array using one of the available expansion channels and continuing to use the first disk while making the expansion disk available to store data, without repositioning data from the first disks to the expansion disk. The expansion disk is not included in any striping of data across the first disks.

As with the preceding method embodiment, an aspect of this method may be setting initial data values on the expansion disk effectively to zeroes. Zeros may be written as initial data values on the expansion disk or one or more flags may be set to indicate that values on the disk should be considered to be zero. Bits or bytes may suitably be used as flags and may be collected in one place on the expansion disk or distributed across the expansion disk. Alternatively, one or more ranges of locations on the disk may be indicated as considered to be zero. These ranges of locations may be updated as portions of the disk are physically initialized. Parity values recorded on the parity disk may be calculated using an XOR or an XNOR of data values across the first disks. If the different calculation of parity values is used, different initial values may be applied. Flags may be used to exclude from parity calculation sections of the expansion disk that have not yet been initialized, effectively setting them to value that preserves the validity of parity values recorded on the parity disk.

Another embodiment is a disk controller including resources, logic and input-output channels adapted to carry out the method embodiment described in the four preceding paragraphs. The aspects of options of the method embodiment are optional features of the disk controller embodiment.

While the present invention is disclosed by reference to the preferred embodiments and examples detailed above, it is understood that these examples are intended in an illustrative rather than in a limiting sense. Computer-assisted processing is implicated in the described embodiments. Accordingly, the present invention may be embodied in methods for implementing and expanding RAID configurations with a dedicated parity disk and without striping, systems including logic and resources to implement and expand RAID configurations with a dedicated parity disk and without striping, media impressed with logic to implement and expand RAID configurations with a dedicated parity disk and without striping, or data streams impressed with logic to implement and expand RAID configurations with a dedicated parity disk and without striping. It is contemplated that modifications and combinations will readily occur to those skilled in the art, which modifications and combinations will be within the spirit of the invention and the scope of the following claims.

We claim as follows:

1. A method of adding an expansion disk to a disk array with at least one dedicated parity disk, including:
storing data on one or more first disks of the disk array, without striping the data across the first disks;
storing parity data for the first disks on a parity disk in the disk array;
adding an expansion disk to the array, the expansion disk having initial data values on the expansion disk that preserve the validity of parity values recorded on the parity disk for the first disks in the disk array.

2. The method of claim 1, wherein the initial data values on the expansion disk are effectively zeros.

3. The method of claim 2, wherein the parity values recorded on the parity disk before adding the expansion disk are calculated as an XOR of data values on the first disks in the disk array.

4. The method of claim 2, wherein the parity values recorded on the parity disk before adding the expansion disk are calculated as an XNOR of data values on the first disks in the disk array.

5. The method of claim 2, further including preparing the expansion for use by writing zeros as initial data values on the expansion disk.

6. The method of claim 2, further including:
preparing the expansion disk for use by flagging a summary table to indicate sections of the expansion disk as effectively having zeros; and
preparing at least one section of the expansion disk for receiving data values by writing zeros as initial data values onto the section.

7. A disk controller including resources, logic and input-output channels adapted to carry out the method of claim 1.

8. A disk controller including resources, logic and input-output channels adapted to carry out the method of claim 2.

9. An article of manufacture including machine readable memory impressed with logic adapted to carry out the method of claim 2.

10. A method of adding an expansion disk to a disk array with at least one dedicated parity disk, including:
storing data on one or more first disks of the disk array, without striping the data across the first disks;
storing parity data for the first disks on a parity disk in the disk array;
adding an expansion disk to the array with sections of the expansion disk and keeping track of sections of the expansion disk as not included in calculation of parity values on the parity disk; and
using background resources or on demand, updating sections of parity values on the parity disk by recalculating the sections of parity values to include corresponding sections of the expansion disk and keeping track of the recalculated sections as having been included in calculation of parity values on the parity disk.

11. A disk controller including resources, logic and input-output channels adapted to carry out the method of claim 10.

12. A disk controller including resources, logic and input-output channels adapted to carry out the method of claim 11.

13. An article of manufacture including machine readable memory impressed with logic adapted to carry out the method of claim 11.

14. The method of claim 10, wherein recalculating the sections of parity values includes reading concurrently from the first disks and writing to the parity disk, whereby no disk in the disk array need be accessed for both a read and a write.

15. A method of writing to a disk array with two or more first disks, at least one dedicated parity disk and one or more available expansion disk access channels, including:
writing data without striping to a particular disk among the first disks in the disk array;
reading concurrently from remaining first disks in the disk array other than the particular disk;
calculating parity values protecting the data destined for the particular disk using data from the remaining first disks; and
writing the calculated parity values to the parity disk, whereby no disk in the disk array need be accessed for both a read and a write to support the write to the particular disk.

16. The method of claim 15, wherein reading concurrently from first disks in the disk array other than the particular disk uses one or more disk access channels with sufficient throughput to not introduce significant latency in transfer from the first disks.

17. The method of claim 15, wherein the parity values recorded on the parity disk are calculated as an XOR of data values on the first disks in the disk array.

18. The method of claim 15, wherein the parity values recorded on the parity disk are calculated as an XNOR of data values on the first disks in the disk array.

19. The method of claim 15, further including:
adding an expansion disk to the disk array using one of the available expansion channels; and
continuing to use the first disks while making available the expansion disk to store data without recalculating pre-expansion parity values on the parity disk to accommodate the expansion disk.

20. The method of claim 19, wherein the parity values recorded on the parity disk are calculated as an XOR of data values on the first disks in the disk array and initial data values on the expansion disk are effectively zeros.

21. The method of claim 19, wherein the parity values recorded on the parity disk are calculated as an XNOR of data values on the first disks in the disk array and initial data values on the expansion disk are effectively zeros.

22. The method of claim 15, further including:
adding an expansion disk to the disk array using one of the available expansion channels; and
continuing to use the first disks while making available the expansion disk to store data without repositioning data from the first disks to the expansion disk.

23. A disk controller including resources, logic and input-output channels adapted to carry out the method of claim 15.

24. A disk controller including resources, logic and input-output channels adapted to carry out the method of claim 19.

25. An article of manufacture including machine readable memory impressed with logic adapted to carry out the method of claim 15.

26. An article of manufacture including machine readable memory impressed with logic adapted to carry out the method of claim 19.

27. The method of claim 15, further including:
adding an expansion disk to the disk array using one of the available expansion channels; and
continuing to use the first disks while making available the expansion disk to store data by recalculating parity values on the parity disk to take into account data values on the expansion disk and keeping track of sections of the expansion disk for which recalculating parity values has been completed.
